(19) United States
(12) Patent Application Publication
(10) Pub. No.: US 2008/0217484 A1
(43) Pub. Date: Sep. 11, 2008

(54) BRAKE FLAP FOR AN AIRCRAFT

(75) Inventor: Klaus BENDER, Hamburg (DE)

Correspondence Address: INGRASSIA FISHER & LORENZ, P.C., 7010 E. COCHISE ROAD, SCOTTSDALE, AZ, 85253, US

(73) Assignee: AIRBUS DEUTSCHLAND GMBH, Hamburg (DE)

(21) Appl. No.: 12/120,384

(22) Filed: May 14, 2008

Related U.S. Application Data
(63) Continuation of application No. PCT/EP2006/010905, filed on Nov. 14, 2006.

(51) Int. Cl. B64C 23/06

(52) U.S. Cl. 244/199.2

(57) ABSTRACT

A brake flap is provided for an aircraft, which brake flap, for the purpose of delaying the aircraft, can be set at an angle relative to the airstream flowing around it. The flap comprises a free edge which when set at an angle is spaced apart from the exterior skin of the aircraft, and generates an edge vortex in the airstream flowing around said aircraft. The free edge comprises a number of individual edge sections that divide the edge vortex into a number of partial vortices.

### CROSS-REFERENCE TO RELATED APPLICATIONS

This application is a continuation of International Application No. PCT/EP2006/010905, filed Nov. 14, 2006, which was published under PCT Article 21(2) and which claims priority to German Application No. 102005054248.4, filed Nov. 15, 2005 and to U.S. Provisional Patent Application No. 60/750,616, filed Dec. 14, 2005, which are all hereby incorporated in their entirety by reference.

### TECHNICAL FIELD

The invention relates to a brake flap for an aircraft, which brake flap, for the purpose of delaying the aircraft, can be set at an angle relative to the airstream flowing around it, wherein the flap comprises an edge which when set at an angle is spaced apart from the exterior skin of the aircraft.

### BACKGROUND

To increase resistance during the landing approach and during the landing, modern commercial aircraft require brake flaps. A known solution to this are flaps on the top of the wing, which flaps are arranged between the landing flaps and the rear spar, and are usually referred to as spoilers. Such flaps can equally be used also for roll control and for decreasing lift. More rarely seen is a solution in which the brake flaps are arranged on the fuselage, usually at the rear. In both cases these are essentially simple sheet metal parts that are set at an angle against the airstream flowing around the aircraft.

By increasing the resistance by means of brake flaps or spoilers, aircraft can fly a steeper landing approach, which among other things can be used to reduce noise in the approach path. However, the noise reduction achieved in this way is partly cancelled out by the noise generated by the brake flap itself. The brake flaps are also used for retardation during the landing procedure.

A significant mechanism in the noise generation on a brake flap is due to the fact that a single pronounced vortex forms on the edge of the flap, as shown in FIG. 1. Normally one end of the flap is hinged to the aircraft, while the edge vortex forms at the free edge that is opposite the hinged end and/or at the lateral edges.

It is at least one object of the invention to create a brake flap for an aircraft that with essentially identical effectiveness causes less noise. In addition, other objects, desirable features, characteristics, and improvements will become apparent from the subsequent summary, detailed description, and the appended claims, taken in conjunction with the accompanying drawings and this background.

### SUMMARY

The at least one object and other objects, desirable features, characteristics, and improvements are provided by a brake flap for an aircraft. The brake flap, for the purpose of delaying the aircraft, can be set at an angle relative to the airstream flowing around it, wherein the flap comprises a free edge which when set at an angle is spaced apart from the exterior skin of the aircraft, and generates an edge vortex in the airstream flowing around the aircraft. The free edge comprises a number of individual edge sections that divide the edge vortex into a number of partial vortices.

An advantageous embodiment of the invention provides for the individual edge sections that divide the edge vortex into a number of partial vortices to be formed by a wave-shaped design of the free edge.

Another advantageous embodiment of the invention provides for the individual edge sections that divide the edge vortex into a number of partial vortices to be formed by a zigzag design of the free edge.

Yet another advantageous embodiment of the invention provides for the individual edge sections that divide the edge vortex into a number of partial vortices to be formed by holes or recesses that are provided near the free edge in the brake flap.

The holes or recesses in the brake flap can be provided in the form of through-perforations in the flap.

As an alternative, the holes or recesses in the brake flap can be provided in the form of depressions that do not perforate the flap.

A further advantageous embodiment of the invention provides for the individual edge sections that divide the edge vortex into a number of partial vortices to be formed by shoulders, lugs or projections provided near the free edge on the surface of the brake flap.

Preferably one end of the flap is hinged to the aircraft while the individual edge sections that divide the edge vortex into a number of partial vortices are provided on the free edge that is opposite the hinged end of the flap.

Another advantageous embodiment of the invention provides for one end of the flap to be hinged to the aircraft, while the individual edge sections that divide the edge vortex into a number of partial vortices are provided on one lateral edge or both lateral edges of the flap.

A further advantageous embodiment of the invention provides for one end of the flap to be hinged to the aircraft, while the individual edge sections that divide the edge vortex into a number of partial vortices are provided on the free edge that is opposite the hinged end of the flap, and on one lateral edge or both lateral edges of the flap.

An advantageous embodiment of the invention provides for the flap to be arranged on the top of the wing of the aircraft.

Another advantageous embodiment of the invention provides for the flap to be arranged on the fuselage of the aircraft.

Preferably, the flap can also be used for roll control of the aircraft.

### BRIEF DESCRIPTION OF THE DRAWINGS

The embodiments of the invention will hereinafter be described in conjunction with the following drawing figures, wherein like numerals denote like elements, and

FIG. 1 a perspective view of part of a brake flap for an aircraft, which brake flap, for the purpose of delaying the aircraft, can be set at an angle relative to the airstream flowing around it, according to prior art;

FIG. 2 is a perspective view of part of a brake flap for an aircraft, which brake flap, for the purpose of delaying the aircraft, can be set at an angle relative to the airstream flowing around it, according to a preferred exemplary embodiment of the invention; and

FIGS. 3a) to e) are perspective views, each showing part of a brake flap for an aircraft, which brake flap, for the purpose of delaying the aircraft, can be set at an angle relative to the airstream flowing around it, according to prior art (FIG. 3a)) and according to several preferred exemplary embodiments of the invention (FIGS. 3b) to e)), wherein FIG. 3c) depicts the exemplary embodiment already shown in FIG. 2.

### DETAILED DESCRIPTION

The following detailed description is merely exemplary in nature and is not intended to limit application and uses. Furthermore, there is no intention to be bound by any theory presented in the preceding background and summary or the following detailed description.

FIG. 1 shows a perspective view of part of a brake flap for an aircraft, which brake flap, for the purpose of delaying the aircraft, can be set at an angle relative to the airstream flowing around it, according to prior art. The flap 10 comprises a free edge 11, which when set at an angle is spaced apart from the exterior skin of the aircraft and generates an edge vortex in the airstream flowing around the aircraft. This edge vortex is a significant source of noise that is generated when the brake flap is set at an angle, and that can be a nuisance during the landing approach.

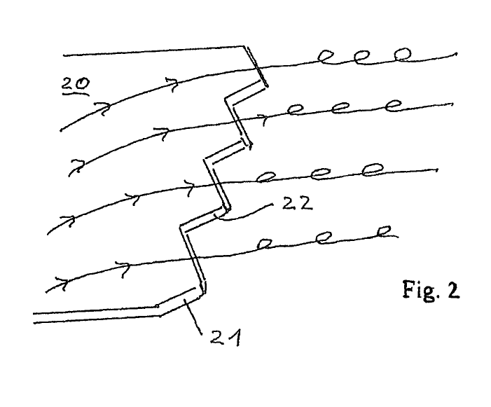

FIG. 2 shows a perspective view of a brake flap 20 for an aircraft according to an exemplary embodiment of the invention, which brake flap, for the purpose of delaying the aircraft, can be set at an angle relative to the airstream flowing around it. The flap 20 comprises a free edge 21, which when set at an angle is spaced apart from the exterior skin of the aircraft and which generates an edge vortex in the airstream flowing around the aircraft. The free edge 21 comprises a number of individual edge sections 22 that divide the edge vortex into a number of partial vortices. In the exemplary embodiment shown in FIG. 2 the individual edge sections 22 comprise a zigzag design of the free edge 21.

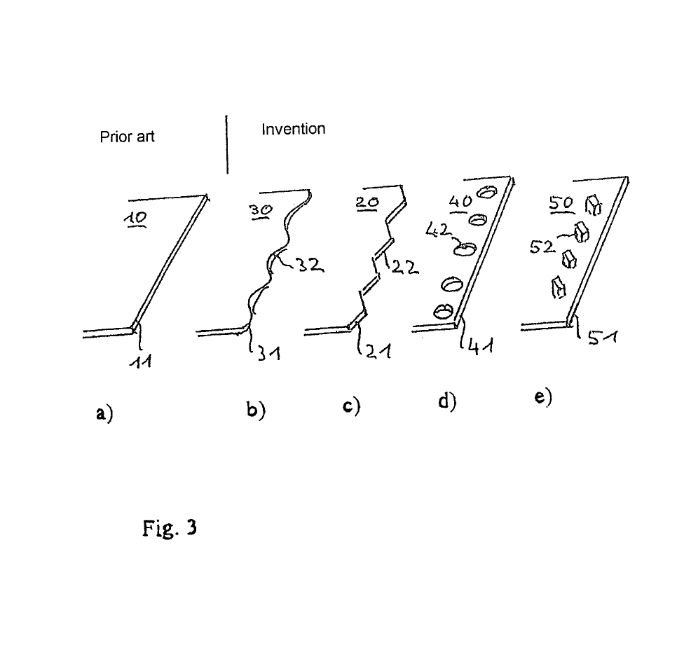

FIG. 3a) shows a perspective view of part of the brake flap 10 for an aircraft, which brake flap has already been shown in FIG. 1, according to prior art.

FIGS. 3b) to e) show perspective views of parts of a brake flap 20; 30; 40; 50 for an aircraft, according to several preferred exemplary embodiments of the invention, which embodiments on the free edge 21; 31; 41; 51 comprise a number of individual edge sections 22; 32; 42; 52 that divide the edge vortex into a number of partial vortices.

In the exemplary embodiment shown in FIG. 3b) the individual edge sections that divide the edge vortex into a number of partial vortices 32 comprise a wave-shaped design of the free edge 31.

FIG. 3c) again shows the exemplary embodiment shown in FIG. 2, in which the individual edge sections 22 comprise a zigzag design of the free edge 21.

In the exemplary embodiment shown in FIG. 3d), the individual edge sections that divide the edge vortex into a number of partial vortices are formed by holes or recesses 42 that are provided near the free edge 41 in the brake flap 40. The holes or recesses 42 provided in the brake flap 40 can be provided in the form of through-perforations in the flap 40, as is the case in the shown exemplary embodiment of FIG. 3d), or they can be provided in the form of depressions on the outside of the flap 40, which depressions do not perforate said flap.

In the exemplary embodiment shown in FIG. 3e), the individual edge sections that divide the edge vortex into a number of partial vortices are formed by shoulders or projections 52 provided near the free edge 51 on the surface of the brake flap 50.

Instead of the exemplary embodiments shown, the edge sections provided on the free edge of the brake flap, which divide the edge vortex into a number of partial vortices, can also be designed in some other way, wherein it is essential that instead of the single noise-generating edge vortex shown in FIG. 1, a number of individual smaller edge vortices are generated, which edge vortices generate less noise and may even be in a position to mutually attenuate or cancel each other out in relation to noise generation. In the context of this application the term “edge sections” refers to sections that are provided in the vicinity of the edge; they need not be constituted by the edge of the flap itself, as is the case in the exemplary embodiments of FIGS. 3b) and c), but instead they can also be provided near the edge, as is the case in the exemplary embodiments shown in FIGS. 3d) and e).

Usually, one end of the flap 20; 30; 40; 50 is hinged on the aircraft, while the individual edge sections 22; 32; 42; 52 that divide the edge vortex into a number of partial vortices can be provided on the free edge 21; 31; 41; 51 of the flap 20; 30; 40; 50, which free edge 21; 31; 41; 51 is opposite the hinged end, i.e. typically at the rear longitudinal edge, as shown in FIGS. 2 and 3b) to e), but as an alternative, or in addition, said individual edge sections 22; 32; 42; 52 can also be provided on the lateral edges of the brake flap.

The flap 20; 30; 40; 50 can be arranged on the top of the wing of the aircraft, as is usually the case in modern commercial aircraft; however, the flap 20; 30; 40; 50 can also be arranged on the fuselage of the aircraft. The flap 20; 30; 40; 50 can in addition be used for roll control of the aircraft.

While at least one exemplary embodiment has been presented in the foregoing detailed description, it should be appreciated that a vast number of variations exist. It should also be appreciated that the exemplary embodiment or exemplary embodiments are only examples, and are not intended to limit scope, applicability, or configuration in any way. Rather, the foregoing detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A brake flap for an aircraft, comprising:
a free edge that when set at an angle is spaced apart from an exterior skin of the aircraft and generates an edge vortex in an airstream flowing around the aircraft; and
a number of individual edge sections of the free edge that divide the edge vortex into a number of partial vortices,
wherein the brake flap is arranged at least on one of a top of a wing and a fuselage of the aircraft.

2. The brake flap of claim 1, wherein the number of individual edge sections that divide the edge vortex into a number of partial vortices are formed by a wave-shaped design of the free edge.

3. The brake flap of claim 1, wherein the number of individual edge sections that divide the edge vortex into a number of partial vortices are formed by a zigzag design of the free edge.

4. The brake flap of claim 1, wherein the number of individual edge sections that divide the edge vortex into a number of partial vortices are formed by holes that are provided near the free edge.

5. The brake flap of claim 4, wherein the holes that are provided in the brake flap are provided with through-perforations.

6. The brake flap of claim 4, wherein the holes that are provided in the brake flap are provided with depressions on the outside of the brake flap, which depressions do not perforate the brake flap.

7. The brake flap of claim 1, wherein the number of individual edge sections that divide the edge vortex into a number of partial vortices are formed by shoulders provided near the free edge on a surface of the brake flap.

8. The brake flap of claim 1, wherein one end of the brake flap is hinged to the aircraft while the number of individual edge sections that divide the edge vortex into a number of partial vortices are provided on the free edge of the brake flap, which free edge is located opposite the one end of the brake flap hinged to the aircraft.

9. The brake flap of claim 1, wherein one end of the brake flap is hinged to the aircraft, while the number of individual edge sections that divide the edge vortex into a number of partial vortices are provided on at least one of lateral edge of the brake flap.

10. The brake flap of claim 1, wherein one end of the brake flap is hinged to the aircraft, while the number of individual edge sections that divide the edge vortex into a number of partial vortices are provided on the free edge that is opposite the one end of the brake flap hinged to the aircraft and on at least one lateral edge of the brake flap.

11. The brake flap of claim 7, wherein the brake flap is also used for roll control of the aircraft.

12. The brake flap of claim 1, wherein the number of individual edge sections that divide the edge vortex into a number of partial vortices are formed by recesses that are provided near the free edge.

13. The brake flap of claim 12, wherein the recesses that are provided in the brake flap are provided with through-perforations in the brake flap.

14. The brake flap of claim 12, wherein the recesses that are provided in the brake flap are provided with depressions on the outside of the brake flap, which depressions do not perforate the brake flap.

15. The brake flap of claim 1, wherein the number of individual edge sections that divide the edge vortex into a number of partial vortices are formed by projections provided near the free edge on the surface of the brake flap.

16. The brake flap of claim 1, wherein one end of the brake flap is hinged to the aircraft, while the number of individual edge sections that divide the edge vortex into a number of partial vortices are provided on the free edge that is opposite the one end of the brake flap hinged to the aircraft and on both lateral edges of the brake flap.
